(19) United States
(12) Patent Application Publication
(10) Pub. No.: US 2004/0211245 A1
(43) Pub. Date: Oct. 28, 2004

(54) System for testing liners

(76) Inventors: Collin Watson, Calgary (CA); Gary Low, Calgary (CA)

Correspondence Address: SEAN W. GOODWIN, 237- 8TH AVE. S.E., SUITE 360, THE BURNS BUILDING, CALGARY, AB, T2G 5C3, CA

(21) Appl. No.: 10/829,956

(22) Filed: Apr. 23, 2004

Related U.S. Application Data
(60) Provisional application No. 60/465,402, filed on Apr. 25, 2003.

(51) Int. Cl. G01M 3/24; G01N 29/14

(52) U.S. Cl. 73/49.2; 73/592

(57) ABSTRACT

A system for testing the integrity of liners for fluid storage tanks prior to filling the tanks with fluid and placing the tanks into service includes a plurality of highly fluid transmissible paths of highly transmissible structure such as geogrid arranged in the interstitial space between the tank and the liner. Vacuum applied to the interstitial space causes fluid to flow through the breaches or leaks in the liner and into the interstitial space. Acoustical equipment is used to detect the sounds of the fluid flow to determine whether the liner and the liner seals are intact.

### CROSS REFERENCE TO RELATED APPLICATION

This application claims priority of pending U.S. Provisional Patent application Ser. No. 60/465,402 filed Apr. 25, 2003, the entirety of which is incorporated herein by reference.

### FIELD OF THE INVENTION

The present invention relates to a system for testing the integrity and seal of an internal liner providing secondary containment in a fluid containing structural envelope and more particularly for vacuum testing the integrity of a geosynthetic liner in a fluid storage tank.

### BACKGROUND OF THE INVENTION

Storage tanks lined with sealed internal geosynthetic liners are well known. The liners are described as bladder seals in U.S. Pat. No. 5,558,245 to White and as leakage protection liners in U.S. Pat. No. 6,431,387 to Piehler.

The tank storage industry has been slow to adopt sealed internal geosynthetic liners because of the many technical difficulties involved in reliably sealing a membrane or liner, particularly in high pressure situations such as created by liquid depths of up to 50 or 60 feet. More particularly, the potential for a leak is highest at seams and seals around discontinuities, such as support beams, sumps, stands, gauge boards, and other structures supported within the tank or penetrations in the internal floor or walls, such as pipes, manways, heating coils, or other penetrations into the tank. Membrane or liner overlap, such as at seams, has the potential for creating microscopic channels which permit fluid to pass through. Further, weld integrity can be compromised when fabrication of the liner is performed in difficult environments such as enclosed spaces, particularly if the environment is humid or contains contaminants.

Reluctance in industry acceptance of liner technology is further compounded by the challenges of establishing reliable tests to verify the integrity of the liner, particularly prior to filling the tank with fluid. Conventional methods of testing such as air pressure channel testing and defect detection procedures are useful verifying seam integrity and the integrity of discrete areas of a liner, but not particularly useful for testing the integrity of internal geosynthetic liners as a whole where there are a plurality of short seams and seals about discontinuities.

To date, Applicants are not aware of effective methods of testing or verifying seam quality before the tank is placed in service, and further which include testing seams around discontinuities.

Conventional integrity testing methods include soap box testing and pick testing. Vacuum boxes have been used with a soapy film on isolated seams and regions to attempt to locally induce air through a membrane liner. These methods are time consuming and expensive as the testing must be repeatedly done in each small area. In addition, they are less effective in testing on vertical planes, and cannot test around a discontinuity, such as a penetrations and attachment, that can occur on the inside of a storage tank. Further, these tests typically cannot mimic the pressures and stresses under which a sealed internal geosynthetic liner will perform once it is placed in service.

Addition of a liner to a storage tank further creates an interstitial space therebetween which acts as a secondary containment in the event there is a breach or leak in the liner. Secondary containment is typically a regulated requirement in many fluid storage environments. Usually, a geotextile is placed within the interstitial space to protect the liner and to conduct fluids entering the interstitial space to conventional monitoring apparatus. In this circumstance, liquid monitoring apparatus have been provided including apparatus as simple as a valve located at the lower perimeter of the storage tank, which acts as a recipient of any fluid draining under the influence of gravity, evidencing a breach at some unknown location in the liner. Unfortunately, these conventional monitoring apparatus detect imperfections in the liner only after a tank which has been placed into service.

Detection after the fact is very costly, typically resulting in down time, sometimes requiring replacement of the interstitial material, and incurring costly procedures for decontaminating or degassing the interstitial space, all of which inhibit the commercial viability of internal geosynthetic liners.

Clearly, there is a need for a testing system which would permit consistent verification of the integrity of the liner before the storage tank is placed into service.

### SUMMARY OF THE INVENTION

The invention provides a novel method of testing liner integrity in a structural envelope prior to filling the envelope with fluid and placing the envelope into service. The application of vacuum to an interstitial space formed between the structural envelope and the liner will result in acoustic disturbance at breaches in the liner integrity, detectable with acoustical equipment. A highly transmissible structure or mesh such as a geogrid is arranged in the interstitial space so as to aid in rapidly distributing vacuum throughout the interstitial space and in another embodiment, the geogrid is arranged in paths between areas of interest such as seals around discontinuities and the source of vacuum.

Thus in a broad aspect of the invention, a leak-testing system is adapted for use with a structural envelope such as a tank containing a sealed internal liner and forming and interstitial space therebetween, the system comprising: at least one port in fluid communication with the interstitial space; and a highly transmissible structure inserted into the interstitial space and extending at least between one or more areas of interest and the at least one port so that when a vacuum is drawn on at least one of the ports, an acoustic disturbance is generated at breaches in the liner. Preferably, the highly transmissible structure is a geogrid material arranged along transmission pathways to areas of particular interest such as those most prone to liner failure and breach.

### BRIEF DESCRIPTION OF THE FIGURES

FIG. 1 is a partial cross-section of a prior art storage tank having a liner forming an interstitial space between the tank and the liner, the space occupied by an interstitial material, the storage tank having a prior art monitoring system accessing the interstitial space; and

FIG. 2 is a perspective, internal and partial section view of a monitoring system of an embodiment of the present invention and illustrating a geogrid distributed throughout the tank and at areas of interest.

### DETAILED DESCRIPTION OF THE PREFERRED EMBODIMENT

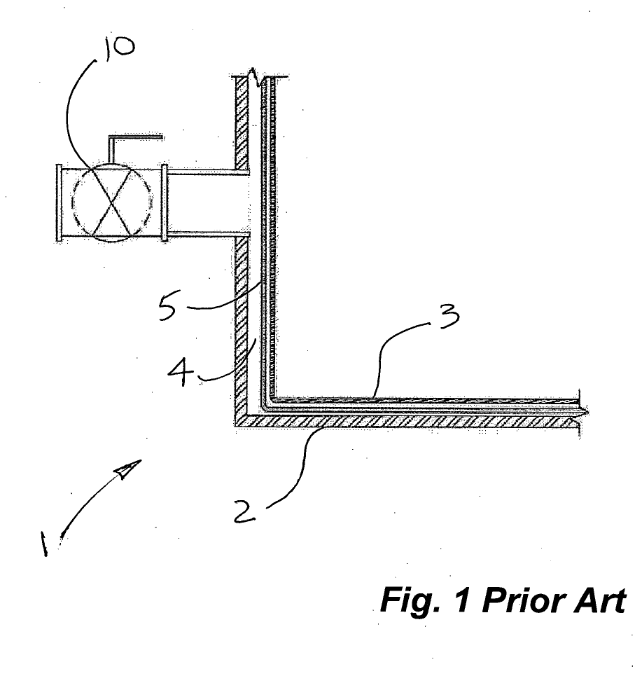

With reference to FIG. 1, a prior art storage tank 1 (FIG. 1) typically has a structural envelope 2 sealed by a liner 3 such as geosynthetic membrane, and forming an interstitial space 4 therebetween. An interstitial material 5 is typically positioned within the interstitial space 4. A monitoring port 10 is shown penetrating the tank 1 and is used to provide detection of flow of liquid within the interstitial space 4 or leaks into the interstitial space 4, whether through a breach in the liner 3 itself or as a result of loss of integrity of the seals in the liner 3.

The interstitial material 5, typically a geotextile, acts as a continuous transmissible and pressure resistant layer within the interstitial space 4. Geotextile materials while not typically highly transmissible, are sufficiently transmissible to conduct fluids to the monitoring port 10 over time.

Geotextiles, as the interstitial material 5, are easy to work with and are inexpensive. Non-woven geotextile materials are widely used in secondary containment, road construction, and other earth lining applications and are designed for transmissibility under pressure, or in other words, to provide a lateral flow of fluid through the material resulting from capillary action. In the case of the prior art monitoring port 10, the leak was detected by a regularly scheduled opening of the monitoring port 10.

An embodiment of a testing system of the present invention is adapted for retrofit use with the prior art tank of FIG. 1 or for new applications. Any periphery of the liner 4 is sealed to the structural envelope 3.

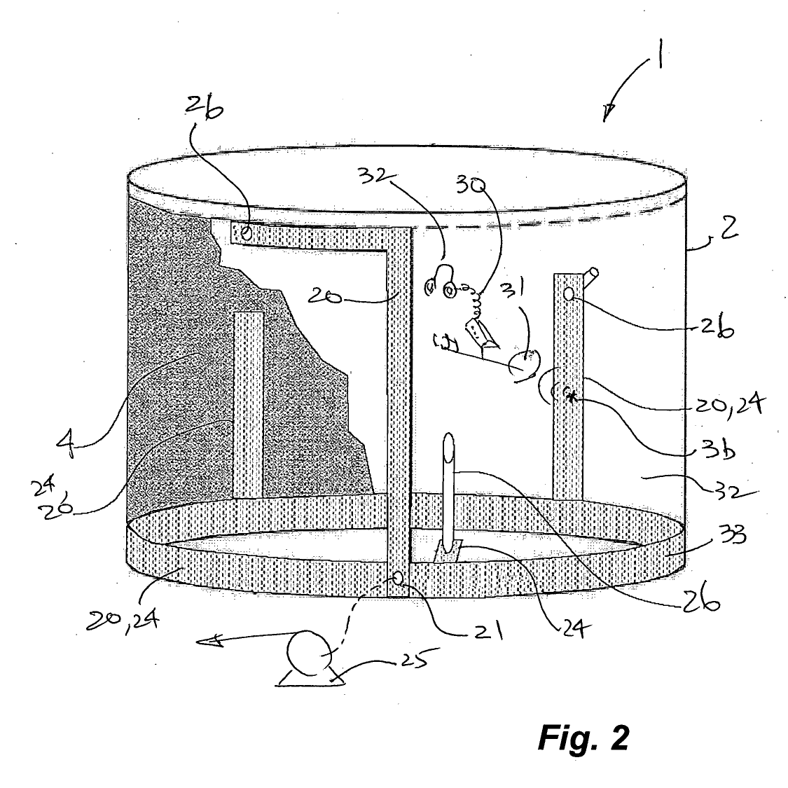

With reference to FIG. 2, in one embodiment of the present invention, a vacuum means or source 25, such as a conventional vacuum pump or blower (not shown), is provided to draw a fluid, such as air, from the interstitial space 4, placing the sealed interstitial space 4 under a partial vacuum. As shown in FIG. 2, the vacuum source 25 is in fluid communication with the interstitial space 4 through at least one vacuum port 21 including a pre-existing and conventional monitoring port 10 of FIG. 1.

Application of a vacuum alone is typically not effective in determining the integrity of the liner 3. Accordingly the detection of fluid flow through seams, seals and breaches in the liner 3 is detected by acoustical monitoring. When vacuum is drawn on one o the ports 25, an acoustic disturbance is generated at breaches in the liner.

Acoustical equipment 30 (operator not illustrated) is used to provide an effective way to detect the acoustic disturbance of sound of the movement of fluid, typically air, from inside the tank 1, through a breach 3b in the liner 3 and into the interstitial space 4 as a result of the vacuum applied to the interstitial space 4. Known acoustical equipment 30 comprises directional microphones 31 that can detect the sound of air passing through channels or apertures in the liner 3 from a distance, together with sensitive head phones 32 that magnify the flow sounds. Examples of suitable acoustical leak detectors 30 are Fisher Research Laboratory models XLT-30 and M-97, available from Fisher Research Laboratory, Los Banos, Calif., USA.

The effectiveness of the acoustical testing, related to the distribution of the vacuum to leak prone areas, can be slowed or otherwise adversely affected by poor transmissibility of the interstitial material 5. Geotextiles are less effective in permitting substantially instantaneous distribution of the vacuum desired for acoustical testing. The resistance of the geotextile material results in a weakening of the vacuum at distances further away from the vacuum port 21. Thus, fluid flow, and thus vacuum distribution, in the interstitial space 4 is further enhanced to ensure leakage detection in remote regions of the liner 3 by the addition of a more highly transmissible structure 20 to the interstitial space 4.

A substantially non-collapsible, transmissible structure 20 such as perforated conduit, materials or mesh such as geogrid material, ensures high transmission of vacuum therealong. Geogrids are flexible synthetic meshes, typically produced from plastics or woven polyesters which have transmissibility along the plane of the material. A suitable transmissible structure 20 is an extruded HDPE geogrid material having a rigid structure which is used to enhance fluid transmission in the interstitial space 4 and provides much faster and stronger flow therethrough, distributing consistent vacuum throughout the tank 1 without collapse.

It is acknowledged that typically leaks occur at particular locations such as seams. Geogrid is more difficult to work with than conventional interstitial material 5, such as geotextile, and is more expensive. Thus, economy can be achieved by providing narrow continuous channels, flow pathways or transmission paths 31 of geogrid arranged along walls 32 or the base 33 of the tank 1 between areas of interest 26, such as seams about discontinuities 26, and the vacuum port 21. The transmissible structure 20 can be installed between the geotextile interstitial material 5 and the structural envelope 2.

Transmission paths 24 may be placed in a regular pattern around the circumference of the tank 1, so as to provide an even rapid distribution of vacuum throughout the interstitial space 4. Optionally, the geogrid transmission paths 24 may be additionally directed to particular areas of interest such as seals about discontinuities 26 and the like, where the risk of leak is more significant and that require the highest quality vacuum for testing purposes.

A variety of devices, including compressors and/or vacuum equipment, can be attached to the at least one vacuum port 21 to create a strong vacuum in the interstitial space 4. Application of vacuum will result in vacuum being distributed rapidly along any transmission path 24 created by the transmissible structure 20, delivering a strong and uniform vacuum throughout the interstitial space 4, allowing for the acoustical detection of leaks or channels through the geosynthetic liner 3, and permitting the effective testing of the sealed internal geosynthetic liner 3 before it is in service.

The embodiments for which an exclusive property or privilege is claimed are defined as follows:

1. A leak-testing system adapted for use with a structural envelope containing a sealed internal liner and forming and interstitial space therebetween, the system comprising:
at least one port in fluid communication with the interstitial space;
a vacuum source adapted to be connected to the one or more ports for drawing a vacuum in the interstitial space;
a highly transmissible structure inserted into the interstitial space; and
acoustic apparatus operated for detecting the sound of fluid passing into the interstitial space through breaches in the liner.

2. The leak-testing system of claim 1 wherein the transmissible structure is a mesh.

3. The leak-testing system of claim 2 wherein the mesh is a geogrid material.

4. The leak-testing system of claim 2 wherein the mesh is extruded high-density polyethylene material.

5. The leak-testing system of claim 1 wherein the transmissible structure is a perforated conduit.

6. The leak-testing system of claim 1 wherein the transmissible structure is formed into one or more transmission paths within the interstitial space for distributing vacuum along the paths to the vacuum source.

7. The leak-testing system of claim 6 wherein the transmissible structure is extruded high-density polyethylene material.

8. The leak-testing system of claim 6 wherein the transmissible structure is a geogrid material.

9. The leak-testing system of claim 6 wherein the transmission paths extend between the at least one port and one or more areas of interest.

10. The leak-testing system of claim 9 wherein the one or more areas of interest include liner seals or areas of potential weakness in the liner.

11. The leak-testing system of claim 1 wherein the vacuum source is a conventional vacuum pump or blower.

12. A leak-testing system adapted for use with a structural envelope containing a sealed internal liner and forming and interstitial space therebetween, the system comprising:
at least one port in fluid communication with the interstitial space; and
a highly transmissible structure inserted into the interstitial space and extending at least between one or more areas of interest and the at least one port so that when a vacuum is drawn on at least one of the ports, an acoustic disturbance is generated at breaches in the liner.

13. The leak-testing system of claim 12 where the one or more areas of interest include liner seals or areas of potential weakness in the liner.

14. The leak-testing system of claim 13 wherein the transmissible structure is a mesh.

15. The leak-testing system of claim 14 wherein the mesh is a geogrid material.

16. The leak-testing system of claim 14 wherein the mesh is extruded high-density polyethylene material.
